(19) United States
(12) Patent Application Publication
(10) Pub. No.: US 2005/0135187 A1
(43) Pub. Date: Jun. 23, 2005

(54) Mixing tool receiver on an output shaft of a mixer

(76) Inventors: Alexander Essing, Idstein (DE); Franz Beron, Manching (DE); Ingo Viehbock, Idstein (DE)

Correspondence Address: MCNAIR LAW FIRM, PA, P.O. BOX 10827, GREENVILLE, SC, 29603-0827, US

(21) Appl. No.: 11/010,183

(22) Filed: Dec. 10, 2004

(30) Foreign Application Priority Data
Dec. 12, 2003 (DE) 103 58 223.1

(51) Int. Cl. B01F 15/00

(52) U.S. Cl. 366/331

(57) ABSTRACT

This invention relates to a mixing tool receiver (1) on an output shaft (13) of a mixer, with a tubular receiver portion (2) into which a shank (16) of a mixing tool (17) can be positively inserted and locked against twisiting. A locking device for the shank features a manually operable slide bushing (6) with a spring-loaded pressure disk (23) slidable on the receiver portion (2) having at least one locking bolt (26, 27) guided in a guide channel (24, 25) in the receiver portion (2). The guide channel (24, 25) in the tubular wall of the receiver portion (2) extends in transverse direction to the longitudinal axis of the receiver and at an incline in the operating direction of the slide bushing (6). The incline extends radially outwardly and is cut so deeply that a cut-through (28, 29) extends into an inside area (3) of the receiver portion. The locking bolt (26, 27) is keyed in the guide channel (24, 25) and slidable over the depth of the channel and, in its radially inside end position in the area of the break-through (28, 29) engages in a circumferential channel (18) in the shank (16) of the mixing tool (17) for the purpose of locking.

### BACKGROUND OF THE INVENTION

This invention relates to a mixing tool receiver on an output shaft of a mixer, with a tubular receiver portion into which one shank of a mixing tool can be positively inserted and, at the same time, be twist-proof, and with means for locking the inserted shank in the receiver portion.

Agitators and mixers are on the market which are able to mix large volumes of construction materials with the construction material being circulated, as a rule, by rotation of a drum which serves, at the same time, as a vessel for the construction material. However, such mixing machines are designed and economically feasible only for applications where construction material is used by the cubic meter.

Manually operable, electrically driven mixing machines are known for stirring and mixing smaller amounts of material and which are also intended for use at construction sites. Stirred and mixed materials are, in particular, ready-mix plasters and mortars, fillers, paints, adhesives and the like.

Compared with the prior state of the art, a manually operable mixing machine known by DE 44 40 566 CI shows significant improvements in terms of its handling and security. Thus, in addition to the power controller located on the first handle and which is operable with one hand, there is also a pushbutton as an on/off switch arranged on the second handle, the pushbutton being operated with the other hand. The mixing rods or the mixing rod ends, respectively, are inserted from the bottom into vertically arranged drive output shafts and there held without twisting and secured against axial forces. To be able to do this quickly and simply, a projection on the lower face-side end of the drive output shaft is engaged in a section of a ring welded onto the mixing rod and axial security is provided by means of a screw on the face side. The screw is screwable into an end-side longitudinal thread of the mixing rod end, and the screw head is exposed on the face-side top edge of the drive output shaft.

This invention is based on the need of optimizing a mixing tool receiver of the above mentioned species, especially to still further simplify handling.

### SUMMARY OF THE INVENTION

This problem is solved according to the invention by providing a locking device feature having a manually operable slide bushing with a spring-loaded pressure disk slidable on a receiver portion. The locking device has at least one locking bolt guided in a guide channel in the receiver portion. The slide bushing is held axially with a bushing collar on the receiver portion, while an annulus is formed between the receiver portion and the slide bushing, the guide channel in the receiver portion. The guide channel extend obliquely to the longitudinal axis of the receiver portion and the operating direction of the slide bushing, and extends radially outwards to the outside of the receiver portion. The channel is cut so deeply that a cut-through results into the inside area of the receiver portion.

The locking bolt is keyed in the guide channel and slidable over the depth of the channel and has such a length that it projects into the annulus in any position with a bolt projection. The bushing collar from the inserting side and the pressure disk in the annulus from the drive side rest against the bolt projection for the purpose of holding and displacing the locking bolt. In a locking position, the locking bolt is displaced by the spring-loaded pressure disk into a radial inside position in the guide channel. The locking bolt protrudes through a cut-through into the inside area of the receiver portion for a locking contact with a locking recess on the shank of the mixing tool. In a release position, the locking bolt is displaced by manually and angularly displacing the slide bushing toward the drive side, by means of the bushing collar, radially outwardly from the area of the locking catch, thus releasing the locking bolt for an inserted shank of the mixing tool.

These measures according to the invention allow the mixing tool to be quickly and safely locked in an axial position. For this, only the shank of the mixing tool must be pushed into the tubular receiver portion. Latching the locking bolt into a recess provided on the shank of the mixing tool is then completed without further action by the operating person. Unlocking is easily and quickly done by the operating person simply moving, with a quick flick of the wrist, the slide bushing and thus the locking bolt into the release position.

Transmission of forces acting on the mixing tool receiver during the operation of the mixer can be improved by providing two diametrically opposed guide channels which are worked into the receiver portion, with one locking bolt being inserted into each guide channel.

In a particularly advantageous aspect, the pressure disk facing the locking bolts is provided with a channel running in the radial direction of movement of the locking bolts. The locking bolts always remain centered in the guide channels during their sliding movement.

A controlled sequence of movement of the locking bolts can be achieved by aligning the length of each locking bolt and the wall defining the annulus, i.e. the inside diameter of the slide bushing, so that during their radial outward movement, before leaving the guide channels, the locking bolts come to rest on the wall of the slide bushing.

A simply designed, fail-safe structure can be realized in a preferred embodiment such that a pressure spring acting on the pressure disk will surround the receiver portion. The spring is propped within the annulus on a guide ring for the slide bushing which in turn rests on a shoulder of the stepped tubular receiver portion.

A rotary engaging connection may be arranged between the mixing tool and tubular receiver portion so that one recess of the receiver portion has a profile corresponding to the shank of the mixing tool. Preferably, the profile is hexagonal.

A simple, functionally safe connection between the mixing tool receiver and the output shaft of the mixer is created wherein a drive end section of the receiver portion is provided with an inside thread. A threaded stem of the output shaft provided with an outside thread into which the drive end of the receiver portion can be screwed. The threaded stem simultaneously serves as a stop for the shank of the mixing tool.

So that the slide bushing remains easy to handle and use, even under adverse conditions on the construction site a circumferential area of the bushing is provided with a plurality of grooves to ensure an intensive and non-slip contact with the hand of the operating person.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 a perspective view of a mixing tool receiver with mixing tool and output shaft;

FIG. 2 again a perspective view of the mixing tool receiver, with the slide bushing omitted;

FIG. 3 a longitudinal section of the mixing tool receiver in a locking position;

FIG. 4 a longitudinal section of the mixing tool receiver in the release position; and

FIG. 5 a sectional view of the mixing tool receiver along line along V-V in FIG. 4.

### DESCRIPTION OF A PREFERRED EMBODIMENT

Referring now in more detail to the drawings, the invention will now be described in more detail.

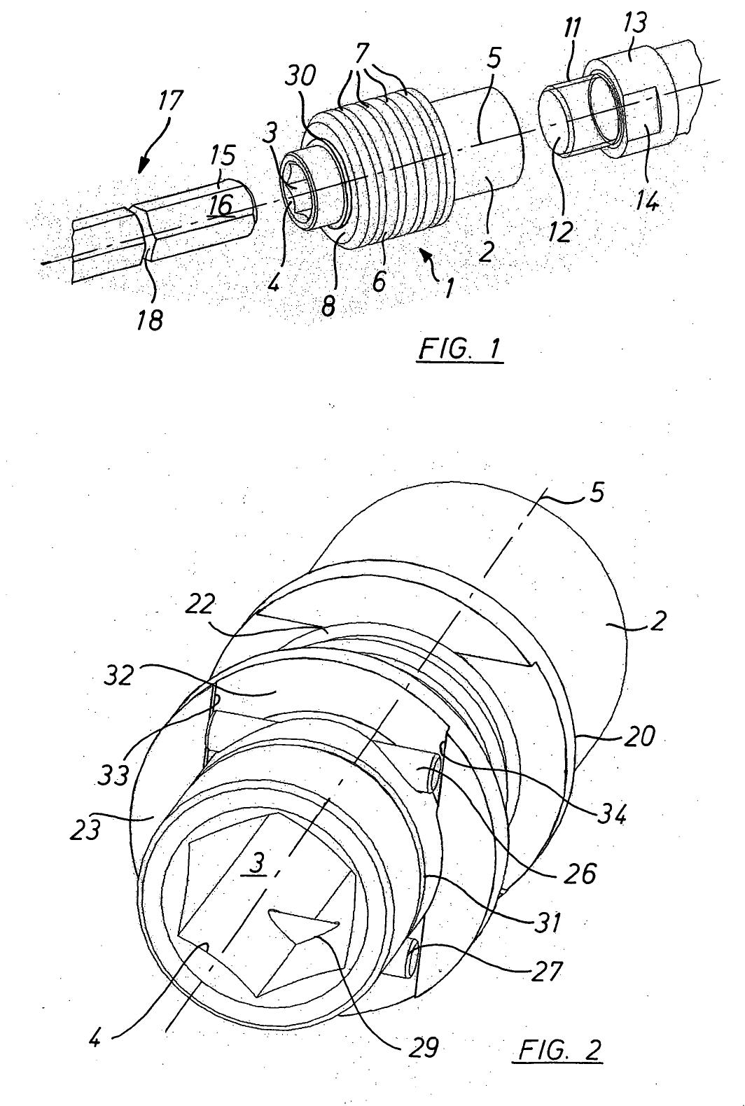

FIG. 1 shows a mixing tool receiver 1 of a manually operable mixer, comprising inter alia, a tubular receiver portion 2, whose inside area 3 is provided with a profile 4, preferably a hexagonal profile. Tubular receiver portion 2 is surrounded by an axially (longitudinal axis 5) movable slide bushing 6 whose circumferential area is provided with a plurality of grooves 7 for better manual handling. A bushing collar 8 forms the face-side end of the slide bushing 6.

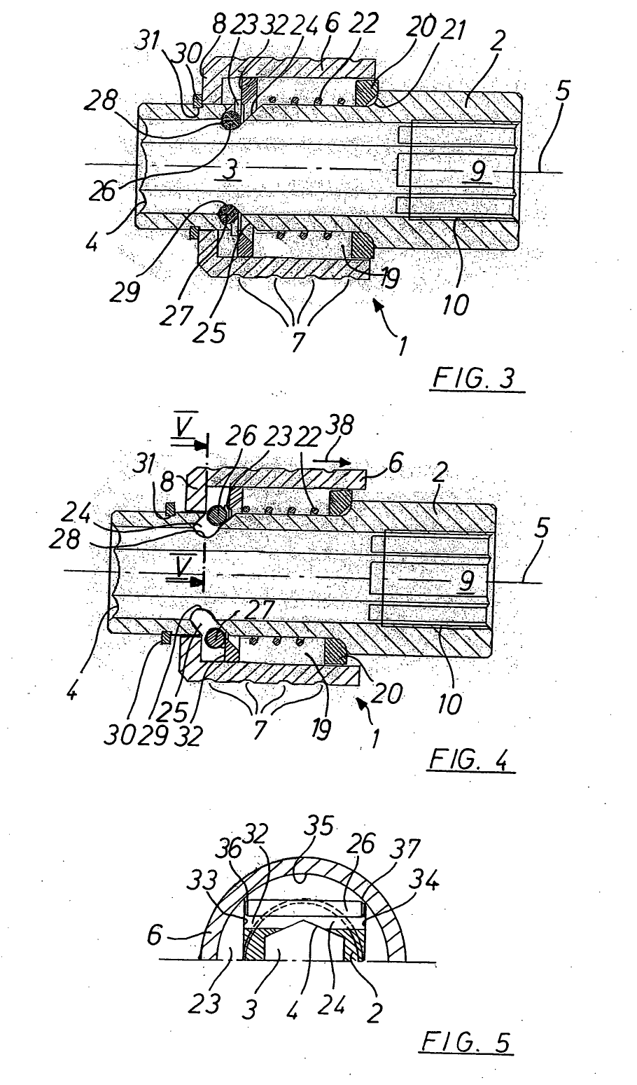

A drive side end 9 of tubular receiver portion 2 is provided with an inside thread 10 (FIG. 3) into which a threaded stem 12 of an output shaft 13 of the mixer can be screwed. The threaded stem is provided with an outside thread 11, with flattenings 14 on both sides provided on the circumference of the output shaft 13 for applying a fork wrench.

Inside area 3 of the mixing tool receiver 1 can receive a shank 16 of a mixing tool 17. The shank is provided with corresponding profile 15. A circumferential channel 18 arranged in the area of the shank 16 is used, as explained further below, to axially lock mixing tool 17 in mixing tool receiver 1.

FIG. 2 illustrates tubular receiver portion 2, with slide bushing 6 omitted so that additional functional elements of mixing tool receiver 1 can be seen which are present in an annulus 19 (FIG. 3, FIG. 4) formed between slide bushing 6 and receiver portion 2.

For this purpose, a guide ring 20 is first provided for axially movable slide bushing 6 wherein the ring rests on a shoulder 21 of the stepped tubular receiver portion 2. On guide ring 20 is positioned a pressure spring 22 surrounding the receiver portion 2. The pressure spring applys a pressure disk 23 on the opposite side which in turn contacts two diametrically opposed locking bolts 26, 27, inserted into guide channels 24, 25 which have been worked into the receiver portion 2.

As can best be seen in FIGS. 3 and 4, the guide channels 24, 25 are formed in tubular receiver portion 2 with the channel length extending obliquely to the longitudinal axis 5 of the receiver. The guide channels extend radially outward toward the outside of the receiver, and obliquely to the operating direction of slide bushing 6. The guide channels 24, 25 are cut in so deeply that a cut-through 28, 29 is formed into the inside area 3 of receiver portion 2.

Each locking bolt 26, 27 is inserted positively and slidably along the channel depth of guide channels 24, 25. The bolts have such a length that they project into annulus 19 so that bushing collar 8 and the pressure disk 23 in annulus 19 engage the respective bolt projection for the purpose of joint holding and displacement of locking bolts 26, 27, as can best be seen in FIGS. 4 and 5.

When the radially inwardly moving locking bolts 26, 27 arrive at the channel bottom of guide channels 24, 25, a stop is created for pressure disk 23 on which pressure spring 22 acts. The axial movement of slide bushing 6 is in turn defined by a stop safety ring 30 which is inserted into a circumferential deepening 31 in receiver portion 2.

The pressure disk 23 is equipped on a side facing locking bolts 26, 27 with a channel 32 along the radial movement direction of locking bolts 26, 27 and receiving them. Here, the two locking bolts are sliding or, respectively, rolling along channel flanks 33, 34 and are thus always centrically guided.

As results from FIG. 5 in particular, the length of each locking bolt 26, 27 and wall 35 of the slide bushing 6, defining annulus 19, are aligned so that the locking bolts will engage, during their radial outward movement prior to leaving the guide channels 24, 25, wall 35 of slide bushing 6 (rests 36, 37).

Mixing tool 17 is now inserted in a positive and torsion-proof axially locking manner into mixing tool receiver I or, respectively, it is removed from the mixing tool receiver 1, in the following manner:

When inserting shank 16 of mixing tool 17 into inside area 3 of tubular receiver portion 2, there is a torsion-proof catch connection already due to the matching profiles 4, 15. At the same time, locking bolts 26, 27 are pushed obliquely, radially outwardly against the spring force of pressure spring 22. The pressure disk 23 is moved in the same manner in the direction of the output shaft 13.

If, upon further insertion of mixing tool 17, the circumferential channel 18 comes into the action area of locking bolts 26, 27, the bolts will latch into the circumferential grove 18. Mixing tool 17 is thus axially locked. Further insertion would also be prevented by threaded stem 12 of output shaft 13 which insofar acts as a stop.

Transferring the mixing tool 17 into the release position is by manually displacing slide bushing 6 toward output shaft 13 (arrow 38). Locking bolts 26, 27 are then displaced by means of the bushing collar 8, obliquely radially outwardly from the area of the locking catch. The inserted shank 16 of the mixing tool 17 is then released.

While a preferred embodiment of the invention has been described using specific terms, such description is for illustrative purposes only, and it is to be understood that changes and variations may be made without departing from the spirit or scope of the following claims.

1. A mixing tool receiver for attachments to an output shaft of a tool driver, said tool receiver being of the type having a tubular receiver portion for receiving a shank of a mixing tool in a twist-proof manner and having means for locking the inserted shank in the receiver portion, wherein the tool receiver comprises:
a locking device for locking the shank in place, including a manually operable slide bushing (6) having a bushing collar (8) slidable carried on the receiver portion (2);
a spring-loaded pressure disk slidably carried by said receiving portion;
at least one inclined guide channel (24, 25) formed in said receiver portion (2);
at least one locking bolt (26, 27) carried in said at least one guide channel;
an annulus (19) formed between said receiver portion (2) and said slide bushing (6);
said at least one guide channel (24, 25) formed in a tubular wall of said receiver portion (2) extending radially obliquely to a longitudinal axis of said receiver portion and in the operating direction of said slide bushing (6);
said at least one guide extending radially into an inside area of said receiver portion to form a cut-through (28, 29) in inside area (3) of said receiver portion, and said locking bolt (26, 27) being keyed in said guide channel (24, 25) and is slidable over a depth of the channel;
said at least one locking bolt having a length so that it projects into said annulus (19) to thereby engage said bushing collar (8) and said pressure disk (23) in said annulus (19) for holding said displacing locking bolt (26, 27);
said locking device having locking position wherein said locking bolt (26, 27) is displaced by said spring loaded pressure disk (23) into a radial inside position in the guide channel (24, 25) and protrudes into said cut-through (28-29) into said inside area (3) of said receiver portion for a locking engagement into a locking recess (18) on said shank (16) and said mixing tool (17); and
said locking device having a release position wherein said locking bolt (26, 27) is displaced by manually sliding said bushing collar and slide bushing (6) toward the tool drive which releases the locking for the inserted shank (16) of mixing tool (17).

2. A mixing tool receiver according to claim 1 including two diametrically opposed guide channels (24, 25) formed in said receiver portion (2), and a locking bolt (26, 27) being inserted into each guide channel (24, 25).

3. A mixing tool receiver according to claim 2 wherein said pressure disk (23) include channel (32) on its side engaging said locking bolts (26, 27) extending in the radial direction of movement of said locking bolts (26, 27), and said channel including channel flanks (33, 34) receiving said locking bolts.

4. A mixing tool receiver according to claim 2 wherein the length of each locking bolt (26, 27) and the wall (35) of the slide bushing (6) defining said annulus (19) is aligned such that the locking bolts (26, 27) come to rest on the wall (35) of the slide bushing (6) during their radial outward movement before leaving the guide channels (24, 25).

5. A mixing tool receiver according to claim 1 including a pressure spring (22) acting upon the pressure disk (23) and surrounding the receiver portion (2), said spring being disposed within said annulus (19) on a guide ring (20) which rests on a shoulder (21) of a stepped tubular receiver portion (2).

6. A mixing tool receiver according to claim 1 wherein said inside area (3) of said tubular receiver portion (2) includes a profile (4) which corresponds with a profile of said shank (16) of mixing tool (17).

7. A mixing tool receiver according to claim 1, characterized in that a drive end (9) of said receiver portion (2) is provided with an internal thread (10), and an output shaft (13) of the mixer includes a threaded stem (12) having an outside thread for threadably mating with said internal thread of said receiver portion.

8. A mixing tool receiver according to claim 1 including a circumferential area of said slide bushing is provided with a plurality of grooves (7) for better manual handling.
